(19) United States
(12) Patent Application Publication
(10) Pub. No.: US 2016/0132475 A1
(43) Pub. Date: May 12, 2016

(54) METHOD AND APPARATUS FOR REPRESENTING EDITABLE VISUAL OBJECT

(71) Applicant: ELECTRONICS AND TELECOMMUNICATIONS RESEARCH INSTITUTE, Daejeon (KR)

(72) Inventors: Ji-Won LEE, Busan (KR); Sang-Hyun JOO, Daejeon (KR); Kyoung-Ill KIM, Daejeon (KR); Si-Hwan JANG, Daejeon (KR)

(21) Appl. No.: 14/825,519

(22) Filed: Aug. 13, 2015

(30) Foreign Application Priority Data
Nov. 10, 2014 (KR) 10-2014-0155589

(51) Int. Cl. G06F 17/24; G06F 17/30

(52) U.S. Cl. CPC G06F 17/24; G06F 17/30247; G06F 17/3028; G06F 17/30292

(57) ABSTRACT

An apparatus and method for representing an editable visual object (EVO) are disclosed. The apparatus for representing an EVO includes a recommendation unit, an editing unit, and a database management unit. The recommendation unit receives the components of a received EVO based on the identification (ID) of the EVO. The editing unit represents the EVO based on the components received from the recommendation unit, and edits the EVO based on information adapted to aid in editing of the EVO. The database management unit performs processing corresponding to a request for the searching of a database when the request is made by the recommendation unit and the editing unit.

### CROSS-REFERENCE TO RELATED APPLICATION

This application claims the benefit of Korean Patent Application No. 10-2014-0155589, filed Nov. 10, 2014, which is hereby incorporated by reference herein in its entirety.

### BACKGROUND

1. Technical Field

The present disclosure relates to a method and apparatus for representing an editable visual object (EVO) and, more particularly, to a method and apparatus for representing an EVO in a simple, concise manner, which are capable of editing detailed components of a given EVO.

2. Description of the Related Art

Conventional visual objects include emoticons and flashcons.

An emoticon can express a user's emotion or transfer simple information using a single image. A flashcon can express a user's emotion or transfer simple information using an image in a flash form which performs a series of predefined operations.

However, these are problematic in that it is difficult or impossible to find a desired one due to the gradually increasing numbers of emoticons and flashcons and also it is difficult to use them as information transfer elements.

As a related technology, Korean Patent Application Publication No. 2014-0103881 discloses a technology for selecting a 3D character having a user-desired image, easily generating various emoticons suitable for a user's demand, such as a dynamic emoticon, an emoticon customized for access context, etc., from the selected 3D character, and then providing the generated emoticons.

As another related technology, Korean Patent Application Publication No. 2005-0054666 discloses a technology for receiving a user-desired emoticon in emoticon editing mode, newly storing the user-desired emoticon, and retrieving the stored emoticon upon creating a text message, thereby enabling an emoticon, input and stored by a user, to be selected and then used.

### SUMMARY

At least one embodiment of the present invention is directed to the provision of a method and an apparatus by which a user can directly edit visual objects and represent and store an EVO, usable for visual communication, etc., using the edited visual objects in a simple, concise manner.

In accordance with an aspect of the present invention, there is provided an apparatus for representing an editable visual object (EVO), including: a recommendation unit configured to receive the components of a received EVO based on the identification (ID) of the EVO; an editing unit configured to represent the EVO based on the components received from the recommendation unit, and to edit the EVO based on information adapted to aid in editing of the EVO; and a database management unit configured to perform processing corresponding to a request for the searching of a database when the request is made by the recommendation unit and the editing unit.

The database management unit, when receiving a request for the components of the EVO from the recommendation unit, may generate the components of the EVO based on an EVO schema corresponding to the EVO and transmit the generated components of the EVO to the recommendation unit.

The EVO schema may include an ID field, a Version field, a DCSLink field, a StartX field, a StartY field, an EndX field, an EndY field, an Angle field, an IsFlip field, a Label field, an ActionCode field, a ContainedEVO field, and a Reserved field.

The EVO schema may be stored in the database.

The apparatus may further include a transmission unit configured to transmit the result of the editing of the editing unit to a counterpart.

The transmission unit may represent the result of the editing of the editing unit in the form of the EVO schema, and may transmit information about the corresponding EVO, represented in the form of the EVO schema, to the counterpart.

The editing unit may request the information adapted to aid in the editing of the EVO from the database management unit, and receives the information.

The information adapted to aid in the editing of the EVO may include a classification (CS) schema in which editing commands and execution information for the EVO are stored, a CS schema in which operation execution information related to a dynamic ID of the EVO is stored, and a CS schema in which editing information when the components of the EVO are initially invoked is stored.

The information adapted to aid in the editing of the EVO may be stored in the database.

The apparatus may further include: a reception unit configured to restore the components of the corresponding EVO based on the received EVO schema-stored file; and a reproduction unit configured to receive reproduction-related information from the database management unit based on the restored components of the EVO, and to reproduce the corresponding EVO.

The EVO may include subordinate EVOs; and the number of levels of the subordinate EVOs included in the EVO can be determined.

In accordance with another aspect of the present invention, there is provided a method of representing an editable visual object (EVO), including: receiving, by a recommendation unit, components of a received EVO based on an identification (ID) of the EVO; representing, by an editing unit, the EVO based on the components; and editing, by the editing unit, the EVO based on information adapted to aid in editing of the EVO.

The receiving the components of the received EVO may include: requesting the components of the EVO from the database management unit; and receiving the components of the EVO that are generated by a database management unit based on an EVO schema corresponding to the EVO.

The method may further include transmitting, by a transmission unit, the result of editing the EVO to a counterpart.

Transmitting the result of editing the EVO may include: representing the result of editing the EVO in a form of the EVO schema; and transmitting information about the corresponding EVO, represented in the form of the EVO schema, to the counterpart.

The method may further include: restoring, by a reception unit, the components of the corresponding EVO based on the received EVO schema-stored file; and receiving, by a reproduction unit, reproduction-related information from the database management unit based on the restored components of the EVO, and reproducing, by the reproduction unit, the corresponding EVO.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the configuration of an apparatus for representing an EVO according to an embodiment of the present invention;

FIGS. 2 and 3 are diagrams illustrating examples of the structure of an EVO schema that is applied to an embodiment of the present invention;

FIG. 4 is a diagram showing the inside of a global database in the database shown in FIG. 1;

FIGS. 5A and 5B are diagrams illustrating the format of an EVO that is applied to an embodiment of the present invention;

FIG. 6 is a diagram illustrating a change in an NEVO object in an embodiment of the present invention;

FIG. 7 is a diagram showing an example of an EVO that is represented when a user invokes a face;

FIG. 8 is a diagram showing an EVO that is changed by the general editing of the EVO;

FIG. 9 is a diagram illustrating a change in an NEVO object attributable to general editing according to an embodiment of the present invention;

FIG. 10 is a diagram illustrating an example of EVO specific editing according to an embodiment of the present invention;

FIG. 11 is a diagram showing a visual object edited in accordance with the command of FIG. 10;

FIG. 12 is a diagram illustrating a change in an EVO according to an embodiment of the present invention;

FIG. 13 is a diagram illustrating another example of EVO specific editing according to an embodiment of the present invention;

FIG. 14 is a diagram showing a visual object edited in accordance with the command of FIG. 13;

FIG. 15 is a diagram illustrating a method of modifying the metadata of an EVO according to an embodiment of the present invention;

FIG. 16 is a flowchart illustrating a method of representing an EVO according to an embodiment of the present invention; and

FIG. 17 is a flowchart illustrating a process ranging from the restoration of an EVO to the reproduction thereof according to an embodiment of the present invention.

### DETAILED DESCRIPTION

The present invention may be subjected to various modifications and have various embodiments. Specific embodiments are illustrated in the drawings and described in detail below.

However, it should be understood that the present invention is not intended to be limited to these specific embodiments but is intended to encompass all modifications, equivalents and substitutions that fall within the technical spirit and scope of the present invention.

The terms used herein are used merely to describe embodiments, and not to limit the inventive concept. A singular form may include a plural form, unless otherwise defined. The terms, including “comprise,” “includes,” “comprising,” “including” and their derivatives specify the presence of described shapes, numbers, steps, operations, elements, parts, and/or groups thereof, and do not exclude presence or addition of at least one other shapes, numbers, steps, operations, elements, parts, and/or groups thereof.

Unless otherwise defined herein, all terms including technical or scientific terms used herein have the same meanings as commonly understood by those skilled in the art to which the present invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Embodiments of the present invention are described in greater detail below with reference to the accompanying drawings. In order to facilitate the general understanding of the present invention, like reference numerals are assigned to like components throughout the drawings and redundant descriptions of the like components are omitted.

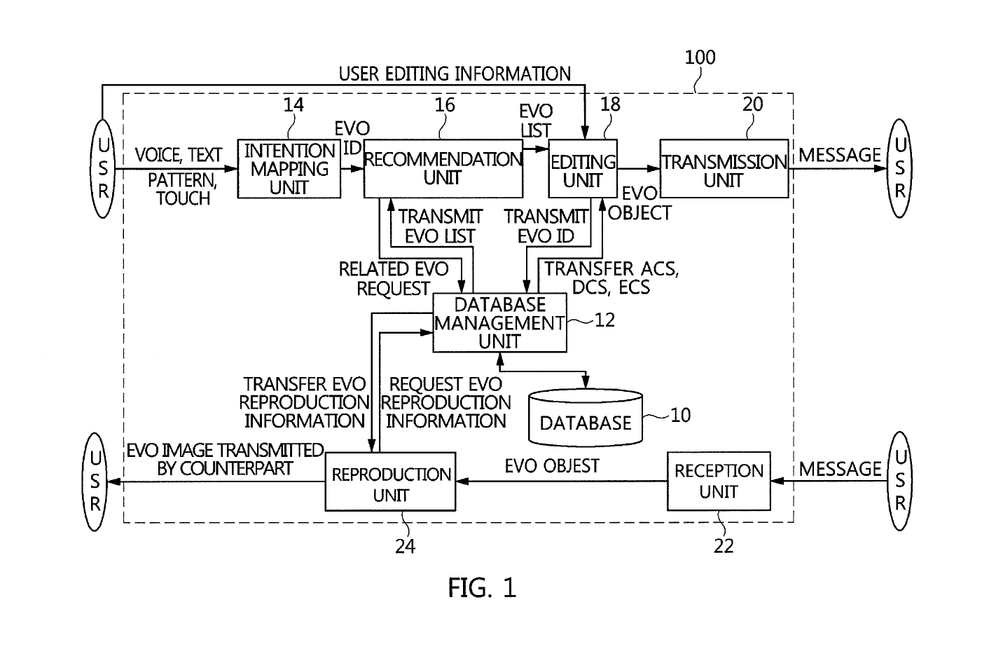

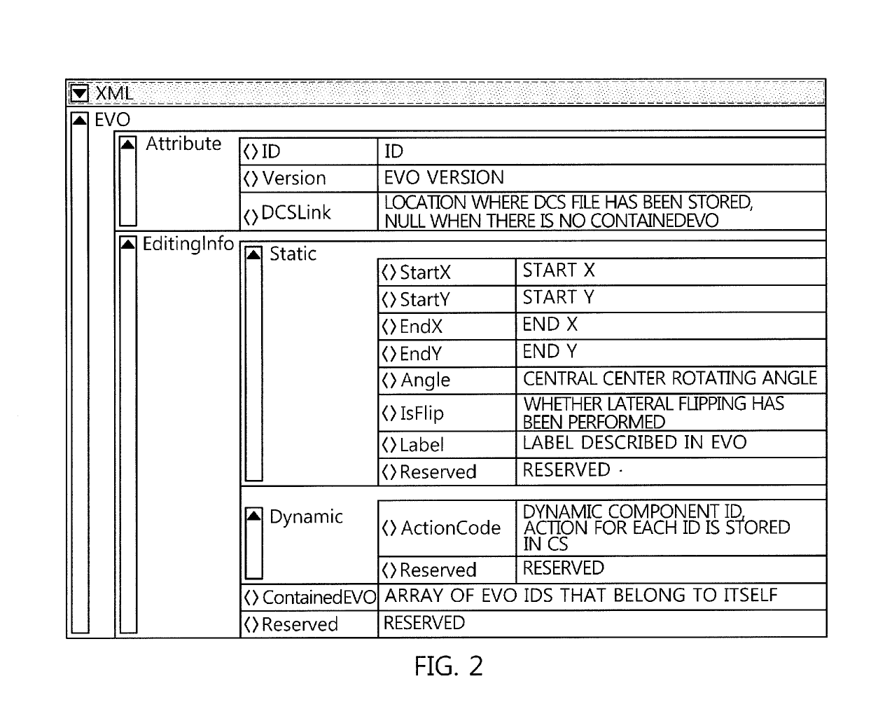

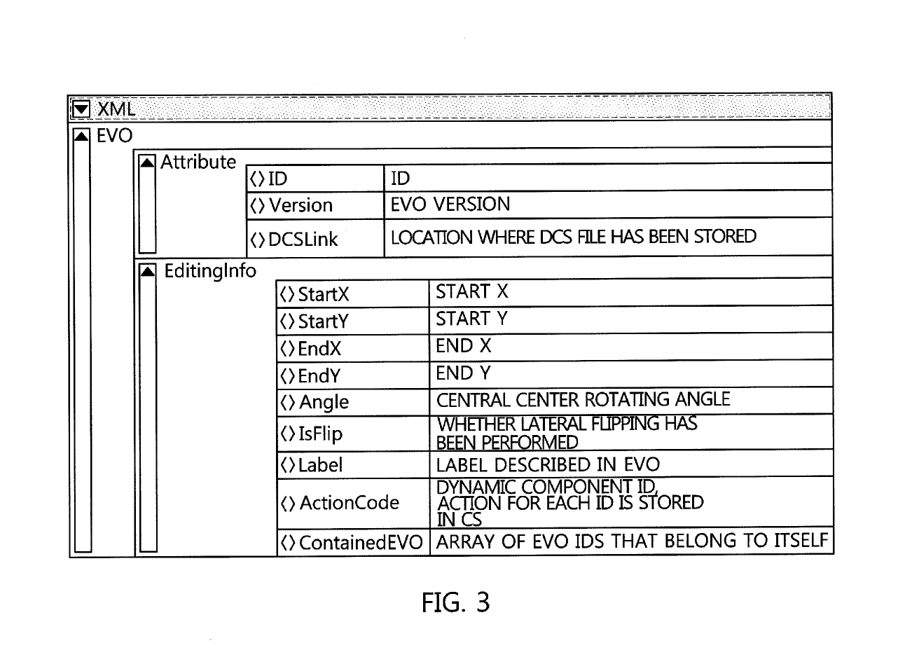

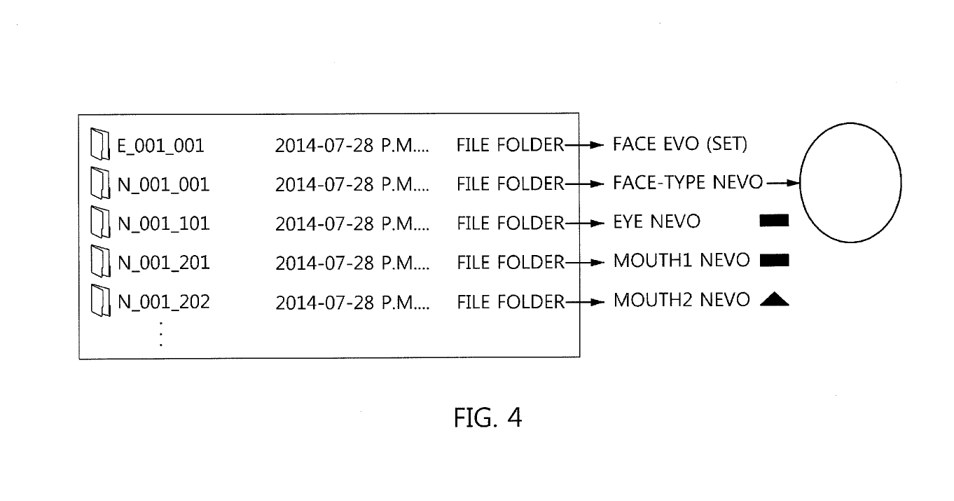

FIG. 1 is a block diagram showing the configuration of an apparatus 100 for representing an EVO according to an embodiment of the present invention. FIGS. 2 and 3 are diagrams illustrating examples of the structure of an EVO schema that is applied to an embodiment of the present invention. FIG. 4 is a diagram showing the inside of a global database in the database shown in FIG. 1.

The apparatus 100 for representing an EVO according to the present embodiment includes a database 10, a database management unit 12, an intention mapping unit 14, a recommendation unit 16, an editing unit 18, a transmission unit 20, a reception unit 22, and a reproduction unit 24.

The database 10 stores various pieces of information that may be used to edit a visual object. For example, the database 10 may include a global database (GDB), a user database (UDB), and a convenience database (CDB). The GDB stores EVOs including basic images, such as a face, a hand, etc., an EVO schema adapted to represent and store EVOs, and a classification (CS) schema adapted to aid in the editing of EVOs. The UDB may be viewed as a subset of the GDB. The UDB is constructed based on EVOs used by a user, and is used to recommend EVO frequently used by the user. The CDB stores EVOs used by the user as desired. The information of the CDB is provided such that the user can easily retrieve and use it.

A single EVO stored in the database 10 may include one or more subordinate EVOs. Furthermore, the maximum number of levels of the subordinate EVOs included in the single EVO may be determined.

The term “EVO” may be applied to various visual objects used in communication, such as a facial expression, time, a context, a building, a food, etc. An EVO is an EVO adapted to represent a specific context or object in a collective manner, and may be viewed as including NEVOs, i.e., minimum units each having an entity (an image).

Of EVOs that depict a context or an object in a collective manner, an EVO that depicts a context is called a context EVO, and an EVO that depicts an object is called a single object EVO. For example, a context EVO may be used to depict (represent) a context, such as the context “in a meeting,” the context “while driving,” or the like. A single object EVO may be used to depict (represent) an object, such as a face (including components, such as eyes, a nose, a mouse, etc.), a watch (including components, such as an hour hand, a minute hand, etc.), or the like. In this case, an EVO itself has no entity (i.e., an image), and has a collective meaning that binds individual images together.

NEVOs include a single object NEVO, i.e., an image having an independently usable meaning, such as a cup, a fire engine, or the like, and a component NEVO EVO, i.e., an image having a meaning as only a component, such as a mouse, an ear, or the like.

NEVOs allow basic editing, such as movement, rotation, and size conversion.

An EVO schema has a structure, such as that of FIG. 2 or 3. FIG. 3 integrates static and dynamic cases on behalf of simplicity. The fields of the schemas shown in FIGS. 2 and 3 are described as follows. The “ID” field corresponds to the unique ID of a corresponding EVO. The “Version” field corresponds to the version of the corresponding EVO. The “DCSLink” field corresponds to a location at which a DCS file of the corresponding EVO has been stored. In the DCS file, the default Editinginfo of a child EVO that belongs to the corresponding EVO has been stored. The “StartX” field corresponds to the start X coordinate (a relative coordinate in the range from 0 to 1) of the EVO. The “StartY” field corresponds to the start Y coordinate (a relative coordinate in the range from 0 to 1) of the EVO. The “EndX” field corresponds to the end X coordinate (a relative coordinate in the range from 0 to 1) of the EVO. The “EndY” field corresponds to the end Y coordinate (a relative coordinate in the range from 0 to 1) of the EVO. The “Angle” field corresponds to the central center rotating angle of the corresponding EVO. The “IsFlip” field corresponds to whether the corresponding EVO has been laterally flipped. The “Label” field corresponds to a location at which entered information has been stored when a letter or a number can be entered into the EVO. The “ActionCode” field represents a dynamic component of the corresponding EVO. The operation method thereof can be identified by checking an ACS file. The “ContainedEVO” field represents an EVO that belongs to itself. The Editinginfo of a ContainedEVO puts information defined in the DCS file before information described in xml of corresponding EVOs. The “Reserved” field is a field reserved for a value that requires additional entry.

A CS schema adapted to aid in the editing of an EVO includes an Editing Classification Schema (ECS) in which the editing command and execution information of an individual EVO (i.e., an individual EVO to which the EVO schema has been applied) have been stored, an Action Classification Schema (ACS) in which operation execution information for the dynamic ID of the individual EVO has been stored, and a Default Classification Schema (DCS) in which editing information when an NEVO, i.e., a component of the individual EVO, is initially invoked has been stored.

In this case, the ECS may include tables set up for respective types of input (for example, voice (V) input, touch (T) input, sensor (S) input and pattern (P) input, etc.). The components of the tables may include a Command field indicative of a value defined by an input signal and a corresponding module, a Current state field indicative of the current state of the EVO, and a Next state field indicative of the state of the EVO changed after the input of the signal. In the Current state of the Current state field, an input signal may be present depending on the state of a current EVO (tripping can be performed during running). When there is no information about a current state, the current state field is left empty. The Next state of the Next state field enables a change in a current EVO (a change in an EVO itself), a change in an NEVO, i.e., a component (a change in an image of the component), and a change in Editinginfo (a physical change, such as movement, rotation, or the like). Furthermore, the Next state may include two or more states that change upon input.

Furthermore, the ACS is a CS schema into which dynamic component information has been entered. The components of tables may include an “ActionCode” field indicative of the name of a dynamic component, and an “ActionDescription” field indicative of a description of an operation (a definition is required).

Furthermore, the DCS is a CS schema in which the initial Editinginfo of component NEVOs within an EVO have been entered. The components of tables may include an “ID” field indicative of the ID of an NEVO, and an “Editinginfo” field indicative of Editinginfo data (for example, StartX, StartY, EndX, EndY, Angle, IsFlip, and Label) that a corresponding NEVO should has in a given EVO.

Assuming that the database 10 includes a GDB, a UDB, and a CDB as described above, EVOs are classified into folders according to their ID in each database. For example, folders may be classified according to EVO IDs in the GDB, as shown in FIG. 4. As described above, there may be XML, image and CS schema files in an EVO folder. In this case, in the case of EVOs, the locations of XML, ECS, ACS and DCS files may be stored. In the case of NEVOs, the locations of XML, image, ECS and ACS files may be stored.

Meanwhile, as shown in FIG. 1, the database management unit 12 performs the search and management of the database 10, and converts a schema into objects and objects into a schema. That is, the database management unit 12 performs related processing when the recommendation unit 16, the editing unit 18 and the reproduction unit 24 request search for content related to the database 10. Furthermore, the database management unit 12 may generate EVO objects (the components of a corresponding EVO, which may be NEVOs) based on an EVO schema, and generates an EVO schema based on EVO objects.

The intention mapping unit 14 receives a user's intention via input, such as voice, text, sensor, touch or pattern input, or the like. Furthermore, the intention mapping unit 14 extracts an EVO ID mapped to the input by searching the database 10 based on the input. Furthermore, the intention mapping unit 14 transfers the extracted EVO ID to the recommendation unit 16.

The recommendation unit 16 requests objects related to a corresponding EVO from the database management unit 12 based on the extracted EVO ID. In this case, the objects related to a corresponding EVO refer to components (which may be NEVOs) required for the representation of the corresponding EVO and the set of the components. For example, assuming that the corresponding EVO is a face EVO, the objects related to a corresponding EVO may be viewed as referring to images of the contour, eyes, nose, mouth, etc. of a corresponding face and the set of these images. Accordingly, the database management unit 12 generates objects related to the corresponding EVO based on the EVO schema of the corresponding EVO. The database management unit 12 transfers an EVO object list in which the objects related to the generated EVO have been entered to the recommendation unit 16. Thus, the recommendation unit 16 transfers the received EVO object list to the editing unit 18. In this case, the objects related to the EVO may be viewed as the components of the EVO described in the attached claims.

The EVO objects (or individual EVOs) refer to forms in which XML-type EVO metadata has been loaded into memory. The EVO objects may be viewed as objects that can embrace all component VEVO images and manage them as a single set. For example, a face EVO may include component NEVOs, such as eyes, a nose, a mouth, etc. Although the corresponding component NEVOs may be independently edited, the editing of the EVO is performed in the overall face is rotated (internal components are rotated while maintaining their locations) or flipped. Accordingly, when EVO objects are requested, not only component NEVOs but also an EVO, i.e., information about the set thereof, are transferred together.

As the editing unit 18 receives the EVO object list, the editing unit 18 represents the EVO in an editing window via the EVO objects generated from the EVO schema. Furthermore, in order to be provided with information required for the editing of the EVO, the editing unit 18 receives a CS schema (i.e., a DCS, an ECS, and an ACS) adapted to aiding the editing of the EVO from the database management unit 12 based on the EVO ID input to the recommendation unit 16. Furthermore, as the editing unit 18 receives user editing information from a user, the editing unit 18 edits the EVO (i.e., the EVO currently displayed on the editing window) based on the CS schema. The editing unit 18 stores the result of the editing as a single EVO object. Furthermore, the editing unit 18 transmits the result of the editing (i.e., an EVO object) to the transmission unit 20.

In FIG. 1, the intention mapping unit 14 may invoke an EVO, desired by a user, chiefly using a voice, a text, or a pattern. For example, a face EVO may be invoked by drawing a circle pattern in an input window (not shown), and a clock EVO may be invoked by issuing the voice command “5 o'clock.”

Meanwhile, in FIG. 1, the user editing information input to the editing unit 18 may chiefly include a voice, a pattern, a touch, and sensor information, by which an invoked EVO may be edited. For example, in the case of a clock EVO, a hour hand may be adjusted from 5 o'clock to 6 o'clock by a touch on an editing window (not shown). A face EVO may be edited into a besotted face form by shaking the apparatus (using a sensor). Furthermore, in the case of a face EVO, tears may be expressed by swiping a portion below an eye downward (using a pattern). Furthermore, a human EVO having a surprised facial expression may be obtained by surprising a human EVO using a voice.

The transmission unit 20 records received EVO objects in the form of an EVO schema, and transmits the EVO information, represented in the form of an EVO schema, to a counterpart. In this case, the recording of EVO objects in the form of an EVO schema means that data recorded on memory is recorded in the form of a file.

The reception unit 22 restores EVO objects based on the received EVO schema-stored file (i.e., a file in which an EVO schema has been stored), and transfers the restored EVO objects to the reproduction unit 24.

The reproduction unit 24 receives a reproduction-related file (for example, an image, XML data, etc.) from the database management unit 12 based on the EVO objects received from the reception unit 22. Furthermore, the reproduction unit 24 reproduces an EVO, edited and transmitted by its counterpart, based on the received data, and displays the reproduced EVO to a user.

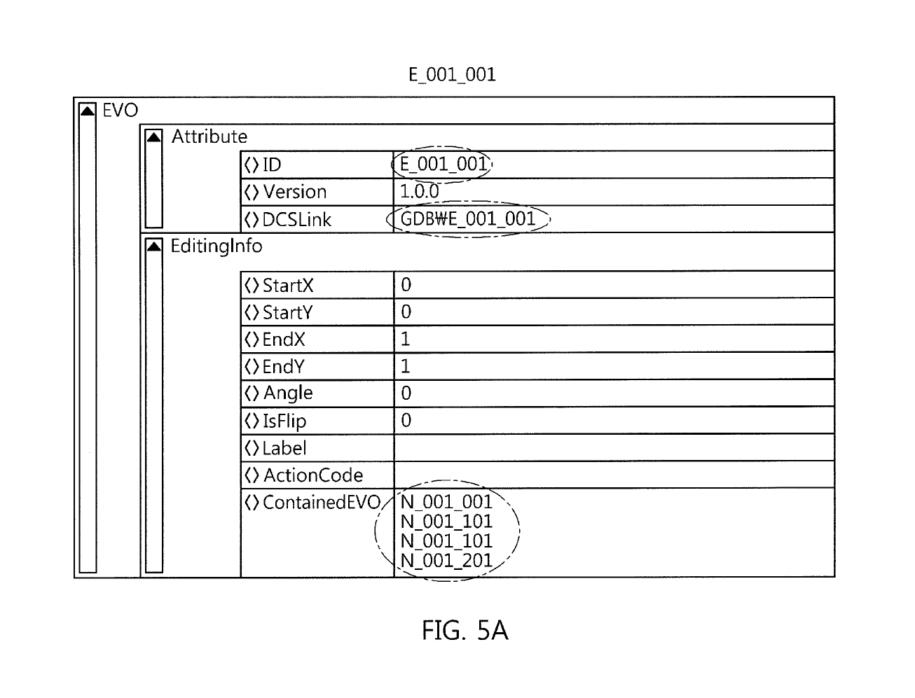

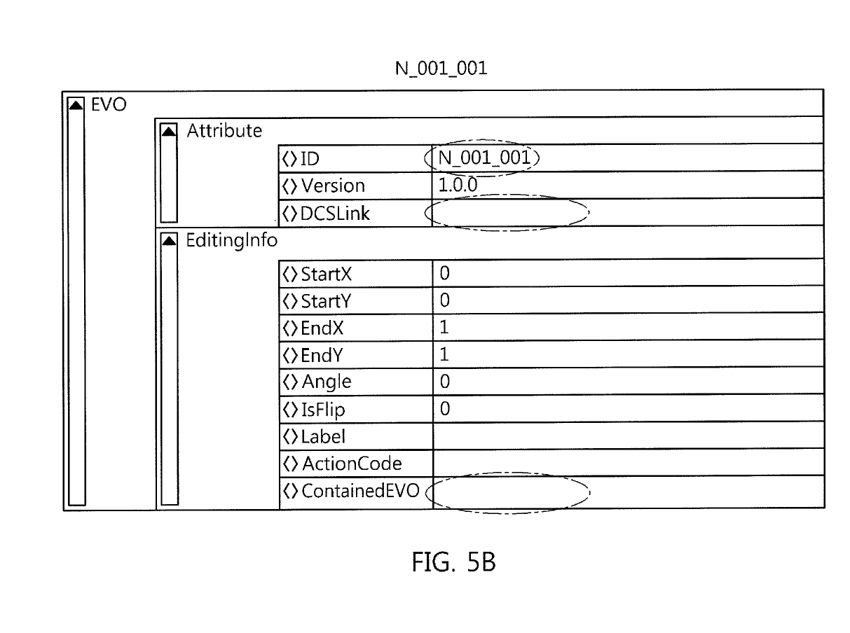

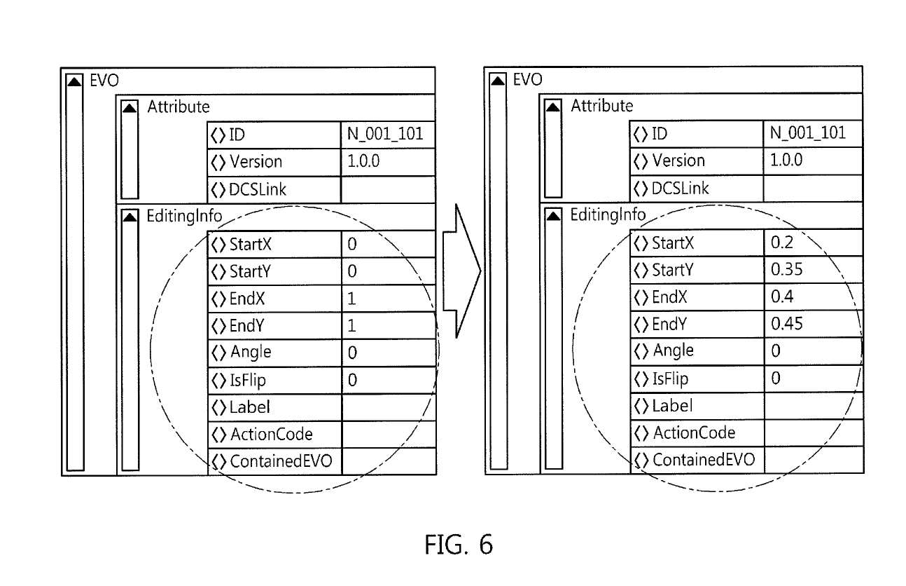

FIGS. 5A and 5B are diagrams illustrating the format of an EVO that is applied to an embodiment of the present invention, and FIG. 6 is a diagram illustrating a change in an NEVO object in an embodiment of the present invention.

For example, assuming that a user invokes a face, the intention mapping unit 14 searches for an EVO ID (for example, E_001_001), mapped to the face, in the GDB of the database 10, and extracts the EVO ID. In this case, the format of an EVO schema having E_001_001 may be the same as that of FIG. 5A.

Thereafter, the recommendation unit 16 receives objects related to the corresponding EVO from the database management unit 12 based on the EVO ID. For example, the database management unit 12 checks the ContainedEVO of the extracted (invoked) E_001_001 (see FIG. 5A), and invokes a related EVO object. In this case, only N_001_001 is illustrated as a representative, as shown in FIG. 5B. Furthermore, the database management unit 12 transfers the invoked related EVO objects to the recommendation unit 16.

FIG. 5A indicates that information is present in DCSLink and ContainedEVO in an EVO (i.e., the EVO of E_001_001), and FIG. 5B indicates that the two pieces of information are absent in an NEVO (i.e., the NEVO of N_001_001).

Meanwhile, in an embodiment of the present invention, the ContainedEVO of an EVO object may be searched for, all component objects may be invoked, a DCS may be checked, and the location of an initial component may be designated. In this case, as shown in FIG. 6, a DCS may be checked, and values in an actual NEVO object may be changed.

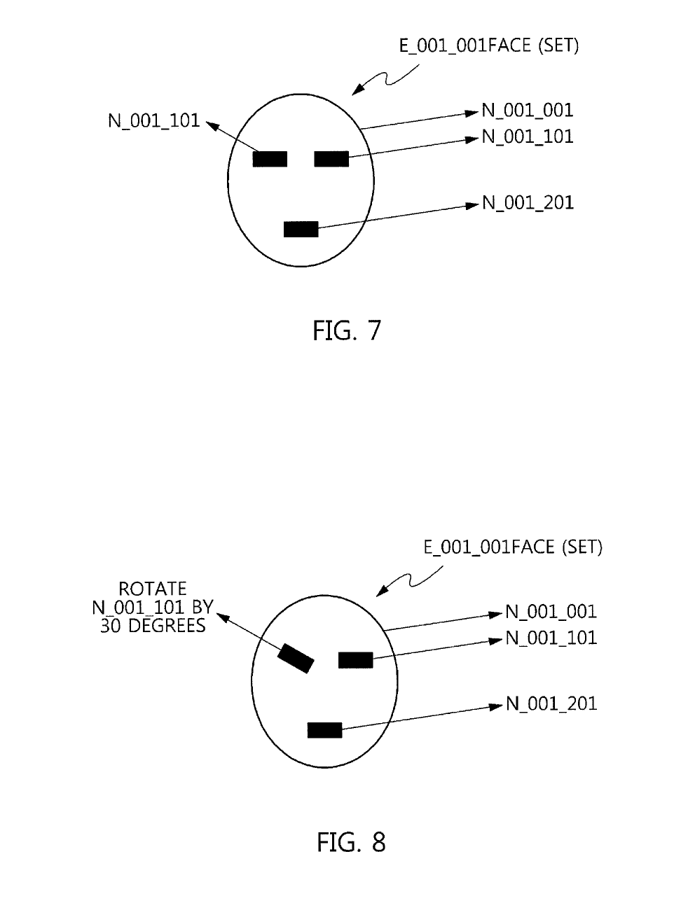

FIG. 7 shows an example of an EVO that is represented when a user invokes a face.

Assuming that a user invokes a face, the intention mapping unit 14 searches for an EVO ID (for example, E_001_001), mapped to the face, in the GDB of the database 10, and transfers the retrieved EVO ID to the recommendation unit 16. The recommendation unit 16 requests an object related to the corresponding EVO from the database management unit 12 based on the received EVO ID. Accordingly, the database management unit 12 checks the ContainedEVO of the retrieved (invoked) E_001_001 (see FIG. 5A), and invokes related EVO objects (including NEVO objects; N_001_001, N_001_101, N_001,_101, and N_001_201). The invoked related EVO objects are listed and transmitted to the recommendation unit 16, and the recommendation unit 16 transmits the EVO object list to the editing unit 18. Accordingly, the editing unit 18 transmits the EVO ID to the database management unit 12, and the database management unit 12 having received the EOV ID checks the DCS of E_001_001 and sets four EVO object values. Furthermore, the set values are transferred to the editing unit 18. In this way, the editing unit 18 represents the “face” EVO, such as that shown in FIG. 7, in the editing window based on the set values.

Now, an EVO that is changed by the general editing of the EVO is described with reference to FIG. 8.

EVO editing may include general editing and specific editing.

The general editing may be applied to all EVOs, and includes rotation, movement, size conversion, flipping, etc. For example, the specific editing may change a face EOV into a surprised face EVO when a user utters “bang” in voice, into an angry face EVO when a user makes three touches, or a loving face EVO when a user inputs a heart pattern.

For example, when a user rotates eyes by about 30 degrees by means of a touch, the editing unit 18 changes the “face” EVO of FIG. 7 into an EVO edited as shown in FIG. 8.

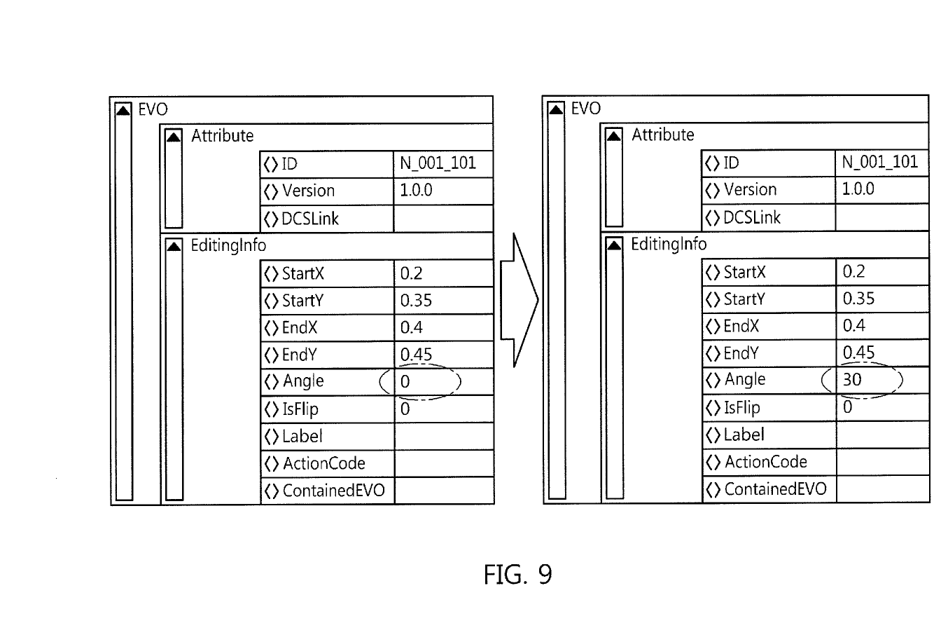

In this case, since an NEVO object has been edited by general editing, the angle field of an N_001_001 object is changed to 30 degrees, as shown in FIG. 9, and the result of the editing is stored, thereby completing the general editing.

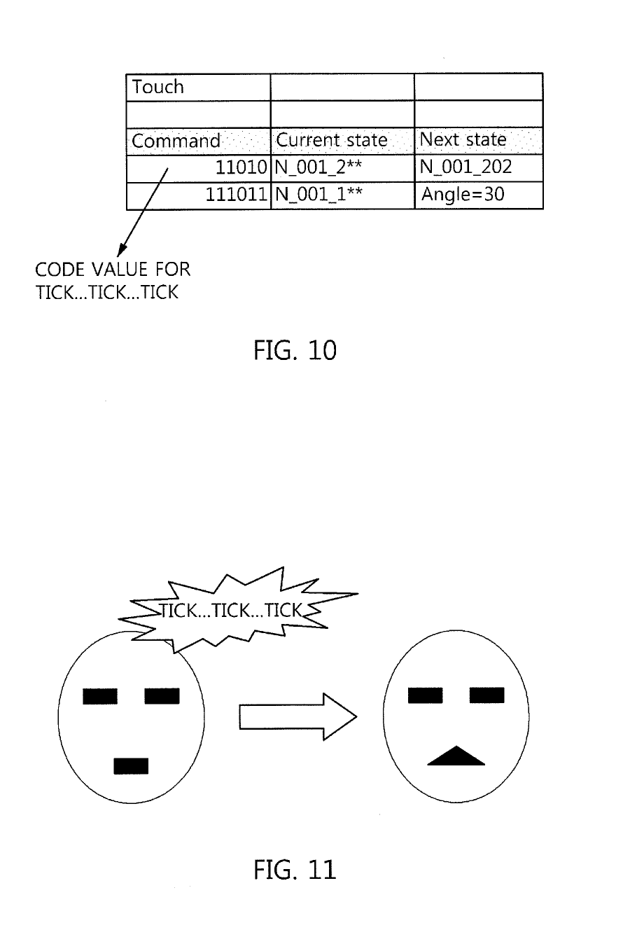

Now, an example of the specific editing of an EVO is described with reference to FIGS. 10 and 11.

The specific editing is an editing method that is specified for a specific EVO and is meaningless to other EVOs. For example, face editing may provide editing meaningful only to a face using a voice, a touch, a pattern, or the like. In this case, an example of specific editing using touch is described.

In the case of EVO specific editing, referring to an ECS file located in an E_001_001 folder, the values of a command field, a current state field, and a next state field can be seen, as shown in FIG. 10. In FIG. 10, when a user makes three touches, the result of the touches is checked in an ECS and editing to be performed is determined. In FIG. 10, a command to unconditionally change an NEVO having N_001_2** into N_001_202 is issued.

In accordance with the command shown in FIG. 10, the editing unit 18 changes the “face” EVO of FIG. 7 into an EVO deformed as shown in FIG. 11.

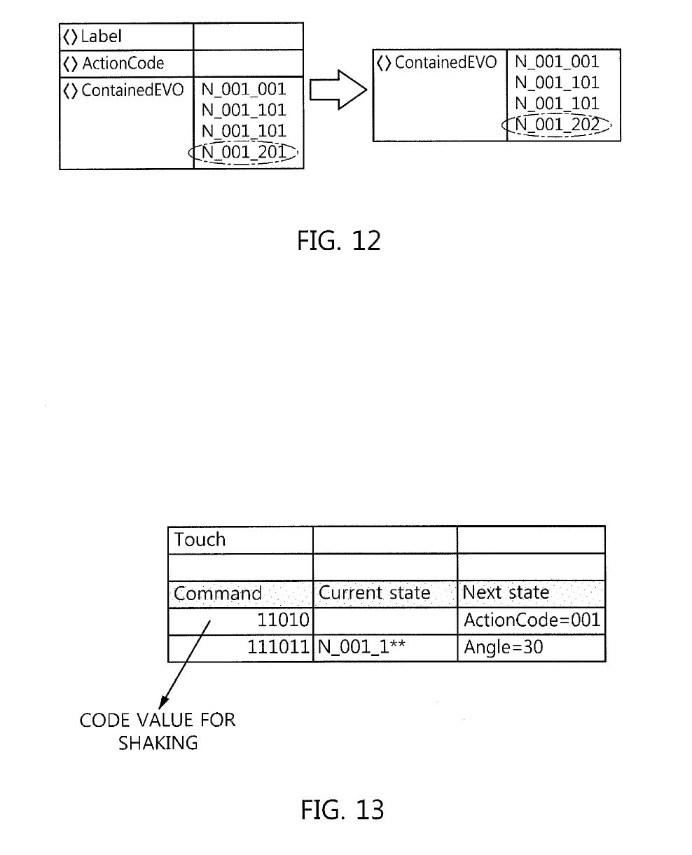

Furthermore, the result (i.e., the result of the data change in the ContainedEVO of the E_001_001 object) of the EVO specific editing is changed as shown in FIG. 12. Thereafter, the N_001_202 object is invoked, Editinginfo is fetched from the N_001_201 object, and the N_001_201 object is eliminated.

Accordingly, the values of the EVO and NEVO object are also changed.

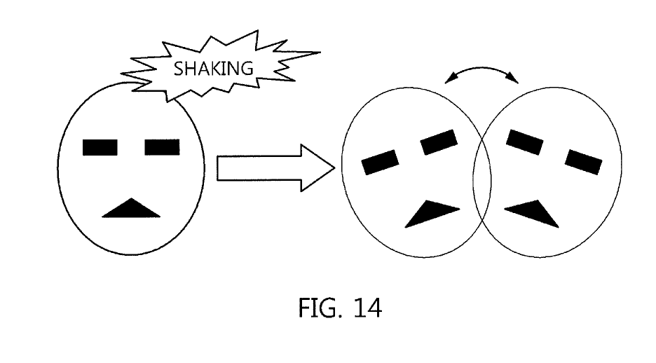

Now, another example of EVO specific editing is described with reference to FIGS. 13 and 14.

When a user performs a shaking operation, a sensor (not shown) transfers a corresponding signal to the intention mapping unit 14. The intention mapping unit 14 searches for an EVO ID mapped to the shaking operation in the GDB of the database 10, and transfers the EVO ID to the recommendation unit 16. The recommendation unit 16 transfers the received EVO ID to the editing unit 18. The editing unit 18 transmits a signal to the database management unit 12 based on the received EVO ID, and the database management unit 12 identifies the meaning of the corresponding sensor input (i.e., a signal instructing that ActionCode will be corrected into 001; see FIG. 13) by checking the ECS of the corresponding EVO ID. Furthermore, the database management unit 12 identifies the meaning of 001 by checking the ACS in the E_001_001 folder. In this case, it is assumed that, as a result of the checking of the ACS in the E_001_001 folder, it is determined that 001 is a command to perform shaking by 20 degrees from side to side for 5 seconds.

Thereafter, the database management unit 12 provides the result of the identification to the editing unit 18.

Accordingly, the editing unit 18 performs deformation so that the face EVO is shaken from side to side, as shown in FIG. 14.

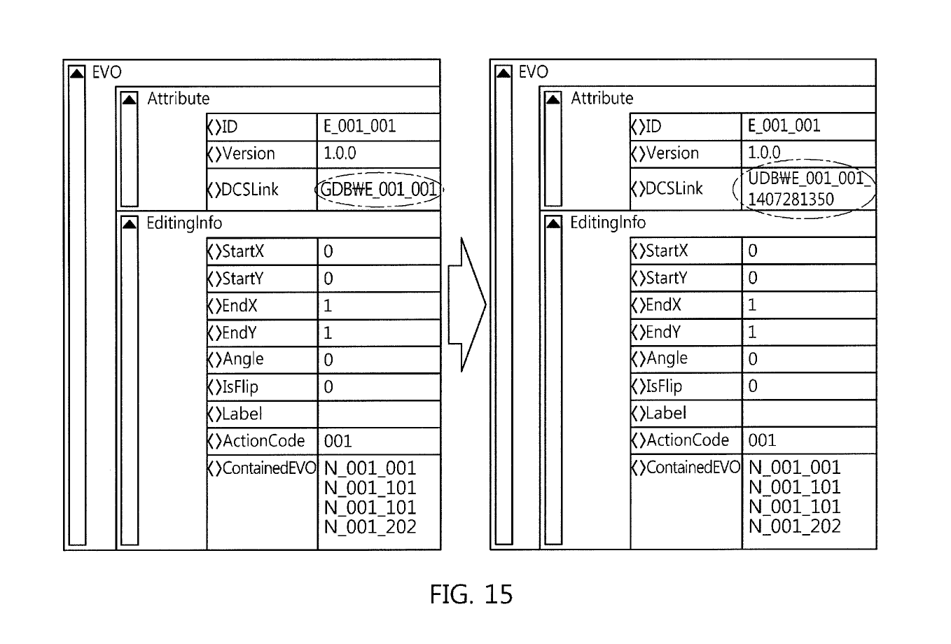

Thereafter, the editing unit 18 stores the result of the editing related to the EVO on which the moving operation has been performed. Since a DCS has been newly created and stored, DCSLink information is modified and stored, as shown in FIG. 15.

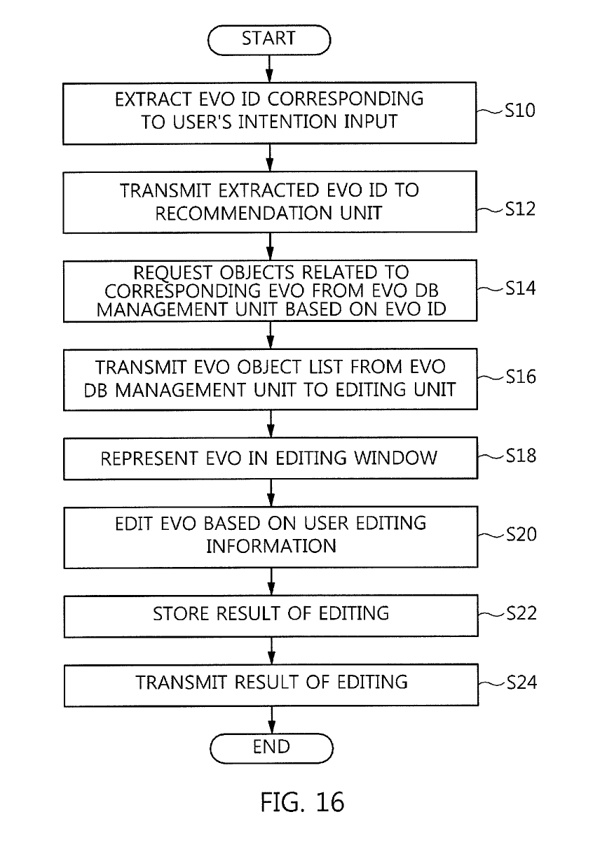

FIG. 16 is a flowchart illustrating a method of representing an EVO according to an embodiment of the present invention.

First, when the intention mapping unit 14 receives a user's intention via a voice, a text, a pattern, a touch or the like, the intention mapping unit 14 extracts a mapped EVO ID through the searching of the database 10 based on the received user's intention at step S10.

Thereafter, the intention mapping unit 14 transmits the extracted EVO ID to the recommendation unit 16 at step S12.

Thereafter, the recommendation unit 16 requests objects related to a corresponding EVO from the database management unit 12 based on the received EVO ID at step S14.

Accordingly, the database management unit 12 generates objects related to the corresponding EVO based on the EVO schema of the corresponding EVO. Furthermore, the database management unit 12 generates an EVO object list in which the objects related to the EVO have been entered to the recommendation unit 16. The recommendation unit 16 transmits the received EVO object list to the editing unit 18 at step S16.

With the reception of the EVO object list, the editing unit 18 represents an EVO in an editing window based on the objects related to the EVO generated from an EVO schema at step S18. Additionally, in order to be provided with information required for EVO editing, the editing unit 18 is provided with a CS schema (i.e., a DCS, an ECS, and an ACS) adapted to assist in EVO editing from the database management unit 12 based on the EVO ID input to the recommendation unit 16.

Thereafter, with the reception of user editing information from the user, the editing unit 18 performs EVO editing corresponding to the user editing information at step S20.

Furthermore, the editing unit 18 stores the result of the editing in the form of a single EVO object at step S22.

Furthermore, the editing unit 18 transmits the result (that is, EVO objects) of the editing to the transmission unit 20 at step S24. Accordingly, the transmission unit 20 records the received EVO objects in an EVO schema, and transmits EVO information, represented in the form of the EVO schema to a counterpart.

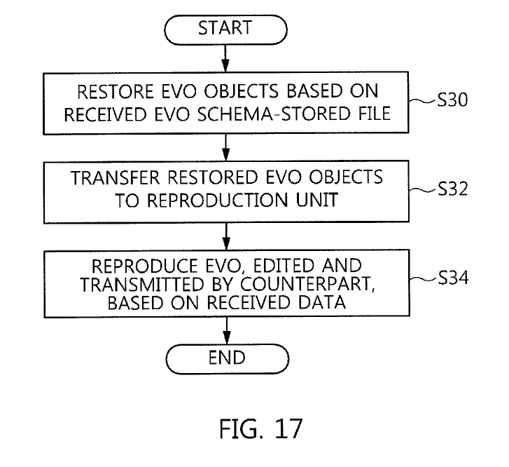

FIG. 17 is a flowchart illustrating a process ranging from the restoration of an EVO to the reproduction thereof according to an embodiment of the present invention.

First, the reception unit 22 restores EVO objects based on an EVO schema-stored file received from a counterpart at step S30.

Furthermore, the reception unit 22 transfers the restored EVO objects to the reproduction unit 24 at step S32.

Accordingly, the reproduction unit 24 requests a reproduction-related file (for example, an image, an XML data, etc.) from the database management unit 12 based on the EVO objects received from the reception unit 22, and receives the requested reproduction-related file. Furthermore, the reproduction unit 24 reproduces an EVO, edited and transmitted by a counterpart, based on the received data and then displays the reproduced EVO to a user at step S34.

According to at least one embodiment of the present invention, an EVO usable online are provided such that they can be easily edited by a user's free intention, and thus can be used in conjunction with various online services.

According to at least one embodiment of the present invention, an EVO according to the present invention can support intuitive and visual communication, and thus can be applied to various application services, such as a tourism service, an education service including a foreign language learning service, a game service, a chatting service, etc.

According to at least one embodiment of the present invention, an EVO according to the present invention can be easily used by anyone almost without learning in an environment in which communication cannot be sufficiently performed, and thus can be applied to various application services in the fields of welfare for foreigners and impaired persons.

As described above, illustrative embodiments have been disclosed in the drawings and the specification. Although the specific terms have been used herein, they have been used merely for the purpose of describing the present invention, but have not been used to restrict their meanings or limit the scope of the present invention set forth in the claims. Accordingly, it will be understood by those having ordinary knowledge in the relevant technical field that various modifications and other equivalent embodiments can be made. Therefore, the true range of protection of the present invention should be defined based on the technical spirit of the attached claims.

What is claimed is:

1. An apparatus for representing an editable visual object (EVO), comprising:
a recommendation unit configured to receive components of a received EVO based on an identification (ID) of the EVO;
an editing unit configured to represent the EVO based on the components received from the recommendation unit, and to edit the EVO based on information adapted to aid in editing of the EVO; and
a database management unit configured to perform processing corresponding to a request for searching of a database when the request is made by the recommendation unit and the editing unit.

2. The apparatus of claim 1, wherein the database management unit, when receiving a request for the components of the EVO from the recommendation unit, generates the components of the EVO based on an EVO schema corresponding to the EVO and transmits the generated components of the EVO to the recommendation unit.

3. The apparatus of claim 2, wherein the EVO schema comprises an ID field, a Version field, a DCSLink field, a StartX field, a StartY field, an EndX field, an EndY field, an Angle field, an IsFlip field, a Label field, an ActionCode field, a ContainedEVO field, and a Reserved field.

4. The apparatus of claim 3, wherein the EVO schema is stored in the database.

5. The apparatus of claim 2, further comprising a transmission unit configured to transmit a result of the editing of the editing unit to a counterpart.

6. The apparatus of claim 5, wherein the transmission unit represents the result of the editing of the editing unit in a form of the EVO schema, and transmits information about the corresponding EVO, represented in the form of the EVO schema, to the counterpart.

7. The apparatus of claim 1, wherein the editing unit requests the information adapted to aid in the editing of the EVO from the database management unit, and receives the information.

8. The apparatus of claim 1, wherein the information adapted to aid in the editing of the EVO comprises a classification (CS) schema in which editing commands and execution information for the EVO are stored, a CS schema in which operation execution information related to a dynamic ID of the EVO is stored, and a CS schema in which editing information when the components of the EVO are initially invoked is stored.

9. The apparatus of claim 8, wherein the information adapted to aid in the editing of the EVO is stored in the database.

10. The apparatus of claim 1, further comprising:
a reception unit configured to restore the components of the corresponding EVO based on the received EVO schema-stored file; and
a reproduction unit configured to receive reproduction-related information from the database management unit based on the restored components of the EVO, and to reproduce the corresponding EVO.

11. The apparatus of claim 1, wherein:
the EVO comprises subordinate EVOs; and
a number of levels of the subordinate EVOs included in the EVO can be determined.

12. A method of representing an editable visual object (EVO), comprising:
receiving, by a recommendation unit, components of a received EVO based on an identification (ID) of the EVO;
representing, by an editing unit, the EVO based on the components; and
editing, by the editing unit, the EVO based on information adapted to aid in editing of the EVO.

13. The method of claim 12, wherein the receiving the components of the received EVO comprises:
requesting the components of the EVO from the database management unit; and
receiving the components of the EVO that are generated by a database management unit based on an EVO schema corresponding to the EVO.

14. The method of claim 13, wherein the EVO schema comprises an ID field, a Version field, a DCSLink field, a StartX field, a StartY field, an EndX field, an EndY field, an Angle field, an IsFlip field, a Label field, an ActionCode field, a ContainedEVO field, and a Reserved field.

15. The method of claim 14, wherein the EVO schema is stored in the database.

16. The method of claim 13, further comprising transmitting, by a transmission unit, a result of editing the EVO to a counterpart.

17. The method of claim 16, wherein transmitting the result of editing the EVO comprises:
representing the result of editing the EVO in a form of the EVO schema; and
transmitting information about the corresponding EVO, represented in the form of the EVO schema, to the counterpart.

18. The method of claim 12, wherein the information adapted to aid in the editing of the EVO comprises a classification (CS) schema in which editing commands and execution information for the EVO are stored, a CS schema in which operation execution information related to a dynamic Ill of the EVO is stored, and a CS schema in which editing information when the components of the EVO are initially invoked is stored.

19. The method of claim 12, further comprising:
restoring, by a reception unit, the components of the corresponding EVO based on the received EVO schema-stored file; and
receiving, by a reproduction unit, reproduction-related information from the database management unit based on the restored components of the EVO, and reproducing, by the reproduction unit, the corresponding EVO.

20. The method of claim 12, wherein:
the EVO comprises subordinate EVOs; and
a number of levels of the subordinate EVOs included in the EVO can be determined.
